(19) United States
(12) Patent Application Publication
(10) Pub. No.: US 2002/0116277 A1
(43) Pub. Date: Aug. 22, 2002

(54) Portable audio system housing a preloaded purchaser selected library od MP3 compressed music titles stored on a hard disk drive

(76) Inventor: Joshua Dickinson Kraft, Austin, TX (US)

Correspondence Address: J.B.KRAFT, 710 COLORADO ST., SUITE 5C, AUSTIN, TX, 87701, US

(21) Appl. No.: 09/785,757

(22) Filed: Feb. 20, 2001

(51) Int. Cl. G06F 17/60

(52) U.S. Cl. 705/26

(57) ABSTRACT

A portable audio system which has 150 up to 500 times the stored MP3 stored music title capacity of present day portable audio system memories. The portable audio system has a housing which encloses a hard disk drive having at least 10 gigabytes of storage capacity with a plurality of music titles stored on said hard disk drive as MP3 compressed digital data. There is also enclosed within the housing at least one pair of audio speakers, means for decompressing said digital data and amplifiers for driving the speakers with said decompressed data to thereby present the music of said music titles. The housing has a handle for manually carrying the housing while said music is being presented. With this implementation, which mounts the hard disk drive with the stored MP3 music titles directly within the carried housing, the portable system is provided with 10 gigabytes or more of MP3 music title storage, which is at least 150 times the capacity of solid state memory devices. Accordingly, whole libraries or collections of music titles may be conveniently stored in the portable system.

### TECHNICAL FIELD

The present invention relates to the distribution, sale and use of music titles, particularly with respect to digitally stored music technology developed as a result of the Internet or World Wide Web (Web) technological revolution.

### BACKGROUND OF RELATED ART

The past decade has been marked by a technological revolution driven by the convergence of the data processing industry with the consumer electronics industry. The effect has, in turn, driven technologies which have been known and available but relatively quiescent over the years. A major one of these technologies is the Internet or Web related distribution of documents, media and programs. The convergence of the electronic entertainment and consumer industries with data processing has spawned many new businesses and technologies involving the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

One recent Internet driven innovation has been the use of MP3 compressed digital data for the transfer, distribution and presentation of music titles through the Internet. By music titles is meant recorded musical presentations from two or three minute tunes or units up to and including usually album-sized recordings in the order of one hour in length. Thus, the dominant sound of the Internet MP3, shorthand for MPEG, Level 3. It does not stand for MPEG 3. MP3 seems to threaten to replace the Compact Disc as today's reigning music distribution standard with dedicated players ready to stand in for WalkPeople, it's really little more than a standard—but one around which an industry is gathered. MP3 takes advantage of the high compression afforded under the MPEG audio standard and uses it as the basis for a file system, which serves as a basis for today's MP3 hardware. The advantage of MP3 is simply compression. It fits audio files into about 1/12 of the space raw digital audio would require. As a result, music that would nominally require a 50 MB file under the WAV format only takes about 4MB. Smaller files mean less transmission time so that entire albums can reasonably be sent across the Internet. It also allows a substantial length of music (an hour or more) to be encoded into solid-state memory and carried about in a no-moving-parts player. It is these solid memory players which are today's MP3 music title portable players. Better still, by squeezing the size of the MP3 file, the data rate required for playing back a file in real-time can be similarly reduced. Instead of requiring the approximately 1.2 mbits/sec to move two CD-quality audio channels, MP3 files need only 64 kbits/sec for near-CD-quality playback. That is not slow enough for real-time playback through a 56K modem (MP3 files are already compressed so modern-based compression cannot appreciably speed up transfer rates). With light network traffic and a 56K modem, you can expect to download an MP3 file from the Web in two to four times its actual playing time. However, with cable “modem”, the download time is much faster.

It should be noted that because MP3 is part of the MPEG-1 standard, it accommodates stereo speakers. An area for great potential for the MP3 music titles presentation has been in the area of personal portable stereo audio systems. For such devices, the MP3 music titles are currently stored in solid state memories in the portable audio systems. These solid state memories have capacities in the order of 64MBs which can provide from one to two hours of music titles. With such portable devices, the user usually accesses and receives the MP3 music titles off the Internet and stores the same in his PC disk hard drive from which he may selectively load such titles onto his portable system memory.

### SUMMARY OF THE PRESENT INVENTION

The present invention provides a portable audio stereo system which has from 150 up to 500 times the stored MP3 stored music title capacity of present day portable audio system memories. The portable audio system of this invention comprises a housing which encloses a disk hard drive having at least 10 gigabytes of storage capacity with a plurality of music titles stored on the hard disk drive as MP3 compressed digital data. There are also enclosed within the housing at least one pair of audio speakers, means for decompressing the digital data and means for driving the speakers with said decompressed data to thereby present the music of said music titles. The housing has means such as a handle for manually carrying said housing while said music is being presented. With this implementation, which mounts the hard disk drive with the stored MP3 music titles directly within the carried housing, the portable system is provided with 10 gigabytes or more of MP3 music title storage, which is at least 150 times the capacity of current solid state memory devices. Accordingly, whole libraries or collections of music titles may be conveniently stored in the portable system. The system may optionally be set up so that the speakers are USB speakers driven by said decompressed digital data instead of analog data. More conveniently, the housing further includes means for converting the decompressed digital data to analog data; and in which the means for driving the speakers drive the speakers with said analog data.

In accordance with another aspect of the present invention, there is provided a method of doing business whereby a purchaser of a portable audio system may be provided with a library of titles all preselected by this purchaser and stored in the portable audio system. The purchaser may be provided access via the Internet to one or many databases, each having a plurality of music titles, each title respectively represented by stored MP3 compressed digital data and enabled to select a set of said music titles, which then may, in turn, be copied as MP3 compressed digital data representative of the set of purchaser selected music titles to the hard disk drive having at least 10 gigabytes of storage capacity within the housing of a portable audio system being purchased by said purchaser. The housing will also include the above-described at least one pair of audio speakers, means for decompressing said digital data, means for driving said speakers with said decompressed data to thereby present the music of said music titles, as well as means for manually carrying said housing while said music is being presented.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of the portable audio system in accordance with the present invention; and

FIG. 2 is a generalized diagrammatic view of an Internet portion showing how the Internet may be accessed to and from the Internet stations to preload purchaser selected MP3 music titles from databases throughout the Internet into the hard drive of the portable audio system being purchased.

### DETAILED DESCRIPTION OF THE PREFERRED EMBODIMENT

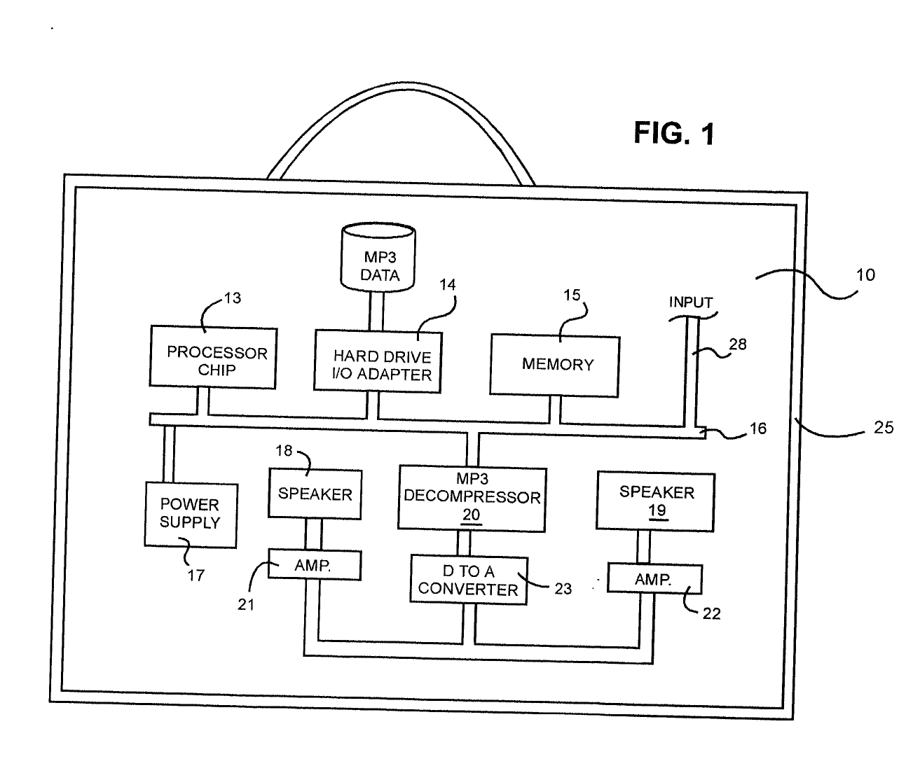

Referring to FIG. 1, a portable audio system 10 has a housing or case 25 and a carrier handle 11. Music titles in MP3 compressed digital form are stored on hard drive 12, which may be any standard hard drive providing at least 10 gigabytes of storage. Input to the hard drive, such as digital data in MP3 form, may be made through input 28 via hard drive I/O adapter interface 14. Power supply 17 is preferably any appropriate standard rechargeable battery. Bus 16 connects the elements in the system. A data processing chip 13 controls the system. The music titles as selected to be played are accessed from the hard drive 12 and stored in memory 15 during the presentation of the music title. The music as presented is output from memory 15 and the MP3 data is decompressed through decompressor 20. The decompressor 20 may be included in the processor chip 13 in which case the processor 13 should be at least a 100MHz Pentium microprocessor since decoding from MP3 requires considerable processor power. The decompressed digital data representative of the music title being presented is put through a digital to analog converter 23 and then coupled to stereo speakers 18 and 19, respectively, through amplifiers 21 and 22. It should be noted that the whole portable audio system may be carried by handle 11 attached to system housing 25. The system may be carried while hard drive 12 is in operation and a selected music title is being presented. The operation of the hard drive is stable and unaffected by any shaking or bouncing of the audio system housing. Thus, the design of the present invention lends itself to use as a “boom box” but with the capacity for storing an immense number of MP3 music titles, i.e. many times the current capacity of “boom boxes”.

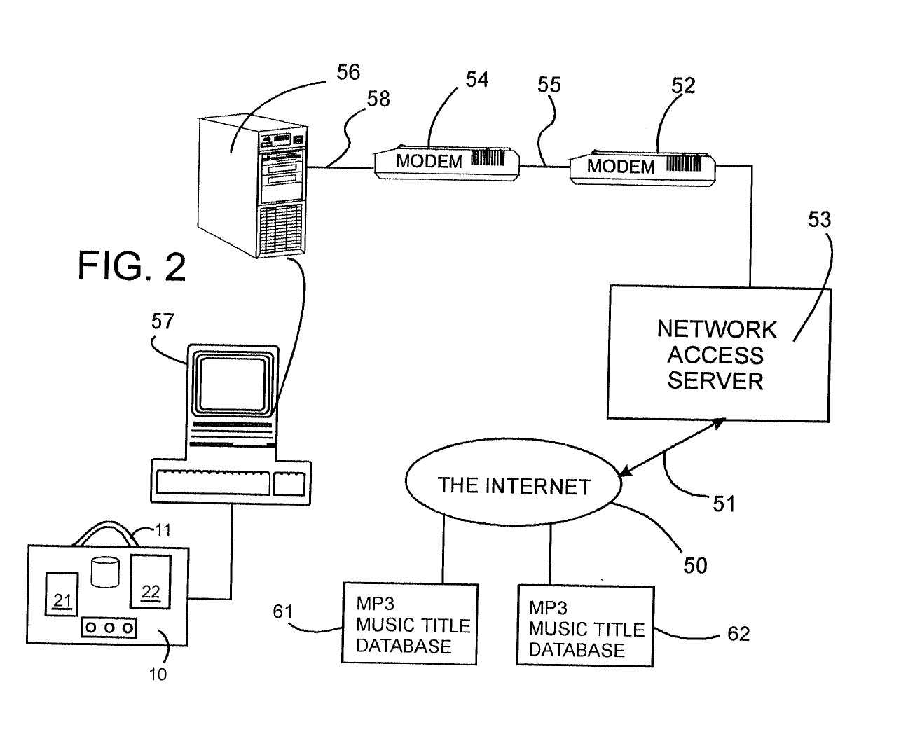

The present invention is particularly effective in the marketing of portable audio systems wherein the purchaser is provided with the ability of selecting a personalized library of 150 hours or more of music titles selected from almost an infinite number of titles available through the Internet. As shown in FIG. 2, at the point of purchase, there is an Internet display station made up of computer 56 and display 57 which is connected, as will hereinafter be described, through the Internet 50 to any of perhaps hundreds of MP3 music title databases as illustrated by Internet sources 61 and 62. The system embodiment of FIG. 2 is one of those known as a “host-dial connection”. Such host-dial connections have been in use for over 30 years through network access servers 53 which are linked 51 to the Internet 50. The servers 53 are maintained by a service provider to the client's display terminal 57. The host's server 53 is accessed by the client terminal 57 through a normal dial-up telephone linkage 58 via modem 54, telephone line 55 and modem 52. The accessed secured data files are downloaded to display terminal 57 through controlling server 53 and computer 56 via the telephone line linkages from server 53, which may have accessed them from the Internet 50 via linkage 51. The user has interactive input to Internet terminal 56/57 as indicated by mouse 27. The user who is purchasing the portable audio system 10 could be offered literally tens of thousands of MP3 music titles. As he selects, for example, 150 hours worth of these MP3 music titles, they are fetched off the Internet from such remote and diverse databases as sources 61 and 62 by using any conventional Web browser. The music titles are then intermediately stored in the hard drive of Internet station computer 56 from which the MP3 music titles are eventually transferred to the hard drive of the audio system 10 being sold to, thus, provide the user with his customized portable audio system with at least 150 hours of selectable MP3 music titles.

Although certain preferred embodiments have been shown and described, it will be understood that many changes and modifications may be made therein without departing from the scope and intent of the appended claims.

1. A portable audio system comprising:
a housing including:
a hard disk drive having at least 10 gigabytes of storage capacity;
a plurality of music titles stored on said hard disk drive as MP3 compressed digital data;
at least one pair of audio speakers;
means for decompressing said digital data;
means for driving said speakers with said decompressed data to thereby present the music of said music titles; and
means for manually carrying said housing while said music is being presented.

2. The portable audio system of claim 1 wherein said speakers are USB speakers driven by said decompressed digital data.

3. The portable audio system of claim 1 wherein said housing further includes means for converting said decompressed digital data to analog data; and wherein said means for driving said speakers drive said speakers with said analog data.

4. The portable audio system of claim 3 wherein said housing further includes:
a system memory; and
means for selectively accessing the data representative of a music title from the hard drive and storing the accessed data in system memory during the audio presentation of said music title.

5. The portable audio system of claim 4 wherein said housing further includes:
a portable rechargeable power supply.

6. A method for providing a purchaser of a portable audio system with a library of purchaser selected music titles stored in said audio system comprising:
providing a database having a plurality of music titles, each title respectively represented by stored MP3 compressed digital data;
enabling said purchaser to select a set of said music titles;
copying the MP3 compressed digital data representative of the set of purchaser selected music titles to a hard disk drive having at least 10 gigabytes of storage capacity within the housing of a portable audio system being purchased by said purchaser;
said housing further including:
at least one pair of audio speakers;
means for decompressing said digital data;
means for driving said speakers with said decompressed data to thereby present the music of said music titles; and
means for manually carrying said housing while said music is being presented.

7. The method of claim 6 wherein said speakers are USB speakers driven by said decompressed digital data.

8. The method of claim 6 wherein said housing further includes means for converting said decompressed digital data to analog data; and wherein said means for driving said speakers drive said speakers with said analog data.

9. The method of claim 8 wherein said housing further includes:
a memory; and
means for selectively accessing the data representative of a music title from the hard drive and storing the accessed data in system memory during the audio presentation of said music title.
